(19) United States
(12) Patent Application Publication
(10) Pub. No.: US 2023/0347536 A1
(43) Pub. Date: Nov. 2, 2023

(54) HAIR COLLECTOR FOR A PIVOTING CUTTING ELEMENT

(71) Applicant: KONINKLIJKE PHILIPS N.V., EINDHOVEN (NL)

(72) Inventors: Reinder Niels LAP, SURHUIZUM (NL); Barend Martinus BINNEMA, DRACHTEN (NL)

(21) Appl. No.: 17/927,920

(22) PCT Filed: Jun. 17, 2021
(86) PCT No.: PCT/EP2021/066383

§ 371 Date: Nov. 28, 2022

(30) Foreign Application Priority Data
Jun. 23, 2020 (EP) 20181709.5

(51) Int. Cl. B26B 19/44

(52) U.S. Cl. CPC B26B 19/44

(57) ABSTRACT

The present invention relates to a hair collector (10) for a hair cutting appliance (100) having a pivoting cutting element (110). The hair collector comprises a first housing part (20); and a second housing part (30). The first housing part comprises a plurality of walls (40). The second housing part comprises a plurality of walls (50). When the hair collector is connected to the hair cutting appliance, the first housing part is adjacent to the hair cutting element and the second housing part is adjacent to the first housing part. When the hair collector is connected to the hair cutting appliance, a cut hair collection chamber is formed, the cut hair collection chamber comprising the plurality of walls of the first housing part, the plurality of walls of the second housing part, and the cutting element. When the hair collector is connected to the hair cutting appliance, the hair collector is configured such that the second housing part can pivot as the cutting element pivots.

### FIELD OF THE INVENTION

The present invention relates to hair collector for a hair cutting appliance having a pivoting cutting element, a hair cutting appliance having a pivoting cutting element and a razor guard to which is connected a hair collector, a hair cutting appliance having a pivoting cutting element and a razor guard to which is integrated a hair collector, and a method of collecting hair from a hair cutting appliance having a pivoting cutting element.

### BACKGROUND OF THE INVENTION

EP3300859A1 describes a beard trimmer which has a handle, a motor and a removable head portion. The head portion has first long hair cutter unit for trimming the hair length that is provided with a non-foil type outer cutter and an inner cutter. A first comb unit is provided having comb elements located adjacent to multiple cutting slots of the outer cutter. One comb element is provided on each of the opposite sides of the outer cutter. Each comb element provided with a row of comb teeth and comb slots separating the comb teeth from another. Each of the comb teeth has a tooth skin contact surface which is located on an elevated upper level relative to a cutter skin contact surface of the outer cutter.

Hair cutting appliances are used to cut human hair, during trimming and shaving. Some hair cutting appliances can provide both shaving and trimming functionality, and as such can be termed hybrid cutting systems. To provide a close and comfortable shave hair cutting appliances can have a cutting element that pivots in order to follow contours of the body, whilst the body of the appliance can remain in a relatively fixed orientation but moved laterally Such a hair cutting appliance, which can be a hybrid hair cutting appliance, can have a cutting element that operates at very high frequencies and that consequently reaches high velocities. A moveable cutting element or cutter can reciprocates at high frequencies of the order of 7000 oscillations per second. Due to this high cutting frequency, the energy transmitted to the hair during the cutting action can be high, leading. This spray can then litter the environment within which the grooming takes place.

There is a need to address this issue.

### SUMMARY OF THE INVENTION

It would be advantageous to have improved means for mitigating the spray of cut hair particles from hair cutting appliances, such as hybrid hair cutting appliances, that have a pivoting cutting element.

The object of the present invention is solved with the subject matter of the independent claims, wherein further embodiments are incorporated in the dependent claims. It should be noted that the following described aspects and examples of the invention apply also to the hair collector for a hair cutting appliance having a pivoting cutting element, the hair cutting appliance having a pivoting cutting element and a razor guard to which is connected a hair collector, the hair cutting appliance having a pivoting cutting element and a razor guard to which is integrated a hair collector, and the method of collecting hair from a hair cutting appliance having a pivoting cutting element.

According to a first aspect, there is provided a hair collector for a hair cutting appliance having a pivoting cutting element, the hair collector comprising:
a first housing part; and
a second housing part.

The first housing part comprises a plurality of walls. The second housing part comprises a plurality of walls. When the hair collector is connected to the hair cutting appliance, the first housing part is adjacent to the hair cutting element and the second housing part is adjacent to the first housing part. When the hair collector is connected to the hair cutting appliance, a cut hair collection chamber is formed, the cut hair collection chamber comprising the plurality of walls of the first housing part, the plurality of walls of the second housing part, and the cutting element. When the hair collector is connected to the hair cutting appliance, the hair collector is configured such that the second housing part can pivot as the cutting element pivots.

In this manner, a hair collector is provided that can enclose a cutting element of a hair cutting appliance with a cutting element that can rotate with respect to a body of the hair cutting appliance to follow the contours of a person's body, such as a shaver/trimmer or other device operating with a reciprocating/trimmer style, to form a closed compartment along with the cutting element to collect cut off hair.

In this way hair cut with a hair cutting appliance with a contour following cutting element that can cut facial and body hair, that operates with a rapidly oscillating or high frequency cutting element, can be collected that otherwise can be uncontrollably sprayed.

Thus, the hair collector operates in conjunction with the cutting element to form a compartment for collecting cut hair, but does not interfere with the cutting element and any associated hair lifting facility associated with the cutting element, such as that provided by a guard.

In an example, when the hair collector is connected to the hair cutting appliance, the hair collector is configured such that the cutting element can contact skin of a user of the hair cutting appliance.

This ensures a smooth and close shave or trim.

In an example, when the hair collector is connected to the hair cutting appliance, the hair collector is configured such that the first housing part does not pivot as the cutting element pivots.

In an example, when the hair collector is connected to the hair cutting appliance, the hair collector is configured such that the second housing part can pivot about an axis that substantially coincides with a pivot axis of the cutting element.

In this manner, the bottom edges of the second housing part can maintain their position with respect to the cutting element as the cutting element pivots with respect to a body of the hair cutting appliance.

In an example, when the hair collector is connected to the hair cutting appliance at least one end wall of the first housing part is configured to conform to at least one end wall of the second housing part.

Thus, cut hair containment is provided even as the second housing part rotates or pivots.

In an example, a curvature of at least one end wall of the first housing part is substantially the same as a curvature of at least one end wall of the second housing part. In this manner, a small gap between the top of the second housing part and the bottom of the first housing part does not get bigger or smaller as the second housing part rotates or pivots, ensuring that cut hairs do not escape from the cut hair collection chamber.

In an example, when the hair collector is connected to the hair cutting appliance at least one end wall of the first housing part overlaps at least one end wall of the second housing part.

In an example, when the hair collector is connected to the hair cutting appliance at least one end wall of the second housing part overlaps at least one end wall of the first housing part.

In other words, the ends of the first housing part can sit over the ends of the second housing part or vice versa, or even one of each extend over the other ends wall, and in this way the cuts hairs are inhibited from escaping from the cut hair chamber.

In an example, at least one end wall of the first housing part has a slot and wherein when the hair collector is connected to the hair cutting appliance at least one end wall of the second housing part is configured to be located within the slot.

In an example, at least one end wall of the second housing part has a slot and wherein when the hair collector is connected to the hair cutting appliance at least one end wall of the first housing part is configured to be located within the slot.

Thus, mechanical stability is provided because one end wall of one housing part slots into the end wall of the other housing part stopping sideways movement, and allowing the second housing part to pivot whilst the first housing part does not pivot. This helps to ensure that cut hair does not escape from the cut hair chamber, even when someone is shaving in a particularly vigorous manner.

In an example, at least one end wall of the first housing part has a recess with a lateral extent and wherein at least one end wall of the second housing part has a lug configured to be located within the recess.

In an example, the recess in the at least one end wall of the first housing part has a radius of curvature centred on the axis about which the second housing part can pivot.

Thus, the second housing part can pivot with a lug on a side wall that fits within a side wall of the first housing part making an angular movement. The arrangement can be such that when the hair collector is connected to the hair cutting appliance the centre of rotation or pivot axis of the second housing part can be located at, or very near to, the rotation or pivot axis of the cutting element. In this way, as the cutting element pivots, the second housing part can pivot with it and maintain its relative spatial position with respect to the cutting element, to optimize cut hair collection.

In an example, at least one side wall of the plurality of walls of the second housing part comprises a structure forming a plurality of openings.

In other words, a semi open filtering system is provided, enabling hair to enter the hair collector and be cut, but where the system blocks hair from leaving the hair collector after it is cut.

In an example, the structure is configured to inhibit hair to pass through the plurality of openings to exit the cut hair collection chamber.

In this manner, the structure functions as a funnel, making it easier for hair to travel in and be cut but harder for hair to travel out.

Thus, in other words a structure of the hair collector wall, or walls, that can be teeth of a comb like element are shaped such that when seen in a hair travelling direction towards the cutting direction they guide hairs, and when seen in the opposite direction they block hairs. This can be for example through having a triangular shape with the apex (that can be rounded) pointing away from the cutting element.

In an example, the hair collector comprises an attachment portion, with the attachment portion configured to attach the hair collector to the hair cutting appliance.

According to a second aspect, there is provided a hair cutting appliance having a pivoting cutting element and a razor guard, configured for shaving and/or trimming, to which is connected a hair collector according to the first aspect.

According to a third aspect, there is provided a hair cutting appliance having a pivoting cutting element and a razor guard, configured for shaving and/or trimming, to which is integrated a hair collector. The hair collector comprises a first housing part and a second housing part. The first housing part comprises a plurality of walls. The second housing part comprises a plurality of walls. The first housing part is adjacent to the hair cutting element and the second housing part is adjacent to the first housing part. A cut hair collection chamber is formed comprising the plurality of walls of the first housing part, the plurality of walls of the second housing part, and the cutting element. The hair collector is configured such that the second housing part can pivot as the cutting element pivots.

According to a fourth aspect, there is provided a method of collecting hair from a hair cutting appliance having a pivoting cutting element, the method comprising connecting a hair collector to the hair cutting appliance. The hair collector comprises:
a first housing part; and
a second housing part.

The first housing part comprises a plurality of walls. The second housing part comprises a plurality of walls. The first housing part is adjacent to the hair cutting element and the second housing part is adjacent to the first housing part. The collection of cut hair is provided via formation of a cut hair collection chamber, the cut hair collection chamber comprising the plurality of walls of the first housing part, the plurality of walls of the second housing part, and the cutting element. The hair collector is configured such that the second housing part can pivot as the cutting element pivots.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic set up of an example of a hair collector for a hair cutting appliance with a schematic set up of an example of a hair cutting appliance also being shown;

FIG. 2 shows a schematic set up of an example of a hair cutting appliance having a hair collector;

FIG. 3 shows a number of views of a hair collector mounted over a cutting element and its driving system (cutting assembly);

FIG. 4 shows a view of a hair collector mounted over a cutting element and its driving system (cutting assembly);

FIG. 5 shows a view of a cutting element and its drive system and two views of a hair collector mounted over the cutting element and its driving system (cutting assembly);

FIG. 6 shows a view of a first housing part of a hair collector mounted to a driving system of a hair cutting appliance showing a recess in a side wall of the first housing part, and in a cross-sectional view and an expanded cross-sectional view a second housing part of the hair collector is mounted to the driving system, with a lug in a side wall of the second housing part being located within the recess;

FIG. 7 shows an example of a hair cutting appliance with a cutting element, which shows a second housing part of a hair collector;

FIG. 8 shows a schematic plan view of hair moving through a wall of a second housing part of a hair collector;

FIG. 9 shows a plan view of an exemplar the alignment of spacings of a second housing part of a hair collector at the top with spacings of a razor guard at the bottom, with an exemplar cutting element also shown; and

FIG. 10 shows a schematic example of the relative alignment of a second housing part of a hair collector with cutting element and razor guard with respect to skin of a user.

### DETAILED DESCRIPTION OF THE EMBODIMENTS

FIG. 1 shows an example of a hair collector 10 for a hair cutting appliance 100 having a pivoting cutting element 110. Essential elements are shown schematically in solid lines and optional elements are shown in dashed lines. FIG. 1 relates to the hair collector 10; however, for representation and context purposes the hair cutting appliance 100 is also shown.

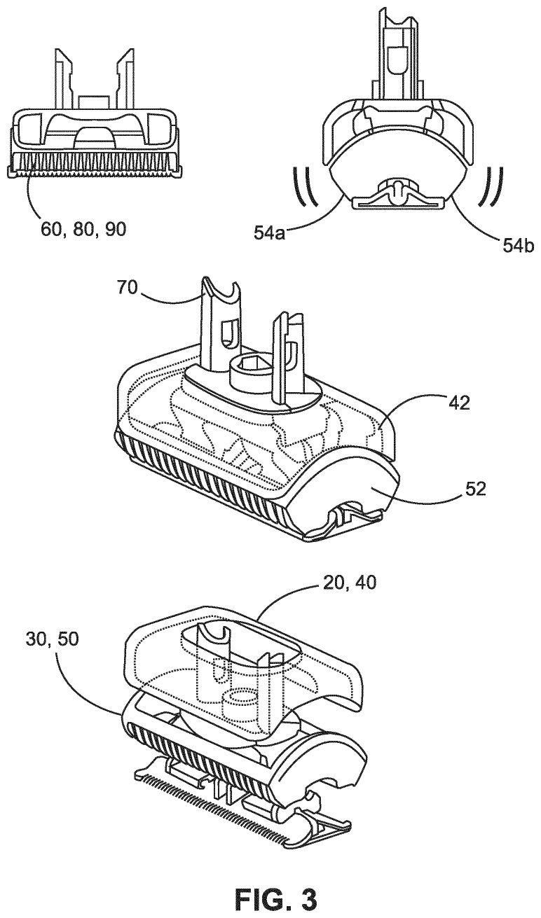

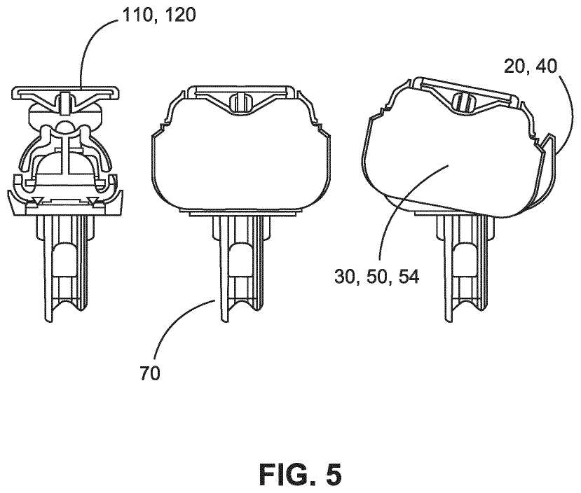

Continuing with FIG. 1 the hair collector comprises a first housing part 20 and a second housing part 30. The first housing part comprises a plurality of walls 40. The second housing part comprises a plurality of walls 50. When the hair collector is connected to the hair cutting appliance, the first housing part is adjacent to the hair cutting element and the second housing part is adjacent to the first housing part. When the hair collector is connected to the hair cutting appliance, a cut hair collection chamber is formed. The cut hair collection chamber comprises the plurality of walls of the first housing part, the plurality of walls of the second housing part, and the cutting element. When the hair collector is connected to the hair cutting appliance, the hair collector is configured such that the second housing part can pivot as the cutting element pivots. This is shown in further detail in FIGS. 3-5.

In an example, when the hair collector is connected to the hair cutting appliance, a drive system for the cutting element is located at least partially within the cut hair collection chamber. Thus a hair collecting space is provided locally, by attaching a reservoir directly to the cutting element, where the reservoir or collecting chamber encapsulates the blade including the driving system of the blade (driving bridge plus ex-center) thereby ensuring that cut hair that otherwise can be sprayed about due to high frequency oscillating parts is contained. This is shown in further detail in FIGS. 3-5.

In an example, a wall of the plurality of walls of the first housing part and the second housing part comprises an opening through which a connection part of a cutting assembly of the hair cutting appliance can be inserted, and wherein the cutting assembly comprises the cutting element. In this way, the hair collector can be placed over the cutting element and then connected to the hair cutting appliance. This is shown in further detail in FIG. 3.

In an example, the hair cutting appliance has a main housing, and wherein when the hair collector is connected to the hair cutting appliance the hair collector is located at least partially around the cutting element between the cutting element and the main housing. This is shown in further detail in FIGS. 3-5.

In an example, the hair cutting appliance is a hybrid hair cutting appliance, configured for both shaving and trimming.

In an example, when the hair collector is connected to the hair cutting appliance, the hair collector is configured such that the cutting element can contact skin of the user of the hair cutting appliance and at the same time the hair collector does not touch the skin of the user. In this way, the hair lifting and guiding function of a guard of the cutting element is not affected, whilst at the same time hair collection of cut hairs that would otherwise be sprayed around is enabled. This is shown in further detail in FIG. 10.

In an example, when the hair collector is connected to the hair cutting appliance, the hair collector is configured such that the cutting element can contact skin of the user of the hair cutting appliance and at the same time the hair collector touches the skin of the user. In an example, the skin is contacted just above the level of the cutting element in front of the razor guard. In this way, maximum collection of cut hairs that would otherwise be sprayed around is enabled and at the same time an improved comfort feeling to the user is provided.

In an example, the edges of the second housing part of the hair collector can be 1 mm above skin level when the cutting element is in contact with the skin. Other spacing distances can be utilized, such as 0.5 mm, 0.75 mm, 1.25 mm, 1.5 mm, 1.75 mm, and 2 mm. In an example, the edges of the second housing part of the hair collector are just above skin level of the user and just in front of the razor guard.

According to an example, when the hair collector is connected to the hair cutting appliance, the hair collector is configured such that the cutting element can contact skin of a user of the hair cutting appliance.

According to an example, when the hair collector is connected to the hair cutting appliance, the hair collector is configured such that the first housing part does not pivot as the cutting element pivots. This is shown in further detail in FIGS. 3-5.

In an example, when the hair collector is connected to the hair cutting appliance, the hair collector is configured such that the first housing part can move towards and away from the cutting element as the second housing part pivots. Thus, as the second housing part rotates or pivots a part of it can push the first housing part upwards if necessary, and the first housing part can then move back downwards. This allows for flexibility of manufacture.

According to an example, when the hair collector is connected to the hair cutting appliance, the hair collector is configured such that the second housing part can pivot about an axis that substantially coincides with a pivot axis of the cutting element. This is shown in further detail in FIGS. 3-5.

According to an example, when the hair collector is connected to the hair cutting appliance at least one end wall 42 of the first housing part is configured to conform to at least one end wall 52 of the second housing part. This is shown in further detail in FIGS. 3-5.

According to an example, a curvature of at least one end wall of the first housing part is substantially the same as a curvature of at least one end wall of the second housing part. This is shown in further detail in FIG. 3.

In an example, a radius of curvature of at least one end wall of the first housing part is substantially the same as a radius of curvature of at least one end wall of the second housing part.

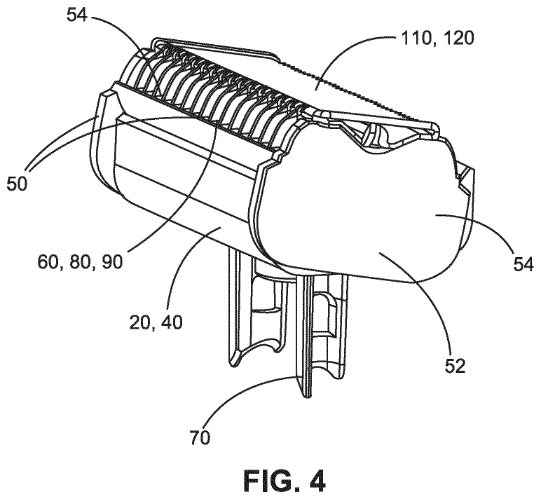

According to an example, when the hair collector is connected to the hair cutting appliance at least one end wall of the first housing part overlaps at least one end wall of the second housing part. Additionally or alternatively when the hair collector is connected to the hair cutting appliance at least one end wall of the second housing part overlaps at least one end wall of the first housing part. Thus, both ends of the movable pivoting part can be inside of both ends of the non-movable (non-pivoting) part, or one end can be inside whilst the other end outside, or both ends of the movable part can be outside of both ends of the non-movable part, as shown in further detail in FIGS. 4-6.

According to an example at least one end wall of the first housing part has a slot and wherein when the hair collector is connected to the hair cutting appliance at least one end wall of the second housing part is configured to be located within the slot.

According to an example at least one end wall of the second housing part has a slot and wherein when the hair collector is connected to the hair cutting appliance at least one end wall of the first housing part is configured to be located within the slot.

According to an example, at least one end wall of the first housing part has a recess 42a with a lateral extent and at least one end wall of the second housing part has a lug 52a configured to be located within the recess.

In an example, both end walls of the first housing part have a recess 42a with a lateral extent and both end walls of the second housing part have a lug 52a configured to be located within respective recesses.

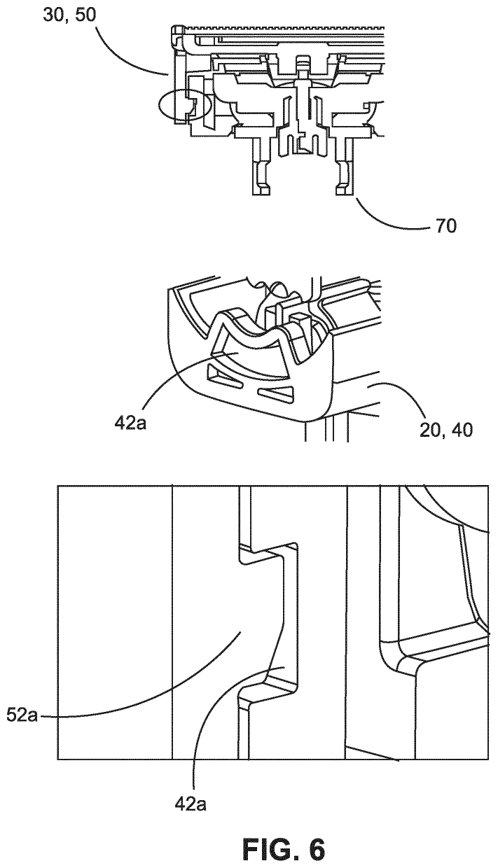

The recess 42a and lug 52a are shown in further detail in the specific example shown in FIG. 6.

In an example, at least one end wall of the second housing part has a recess with a lateral extent and wherein at least one end wall of the first housing part has a lug configured to be located within the recess.

According to an example, the recess in the at least one end wall of the first housing part has a radius of curvature centred on the axis about which the second housing part can pivot.

In an example, the recess in the at least one end wall of the second housing part has a radius of curvature centred on the axis about which the second housing part can pivot.

According to an example, at least one side wall 54 of the plurality of walls of the second housing part comprises a structure 60 forming a plurality of openings. Further detailed examples are shown in FIGS. 3-4, and 7-9.

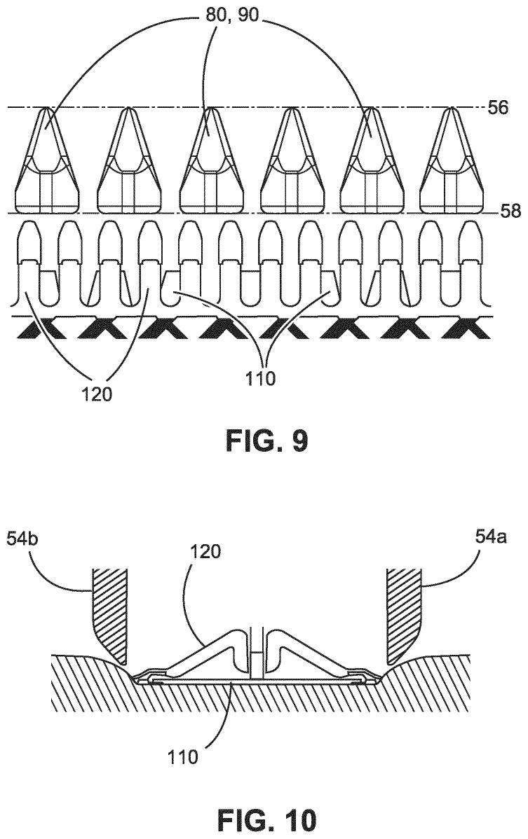

In an example, the structure is configured to enable hair to pass through the plurality of openings to enter the cut hair collection chamber. A schematic exemplar of a detailed embodiment is shown in FIG. 9.

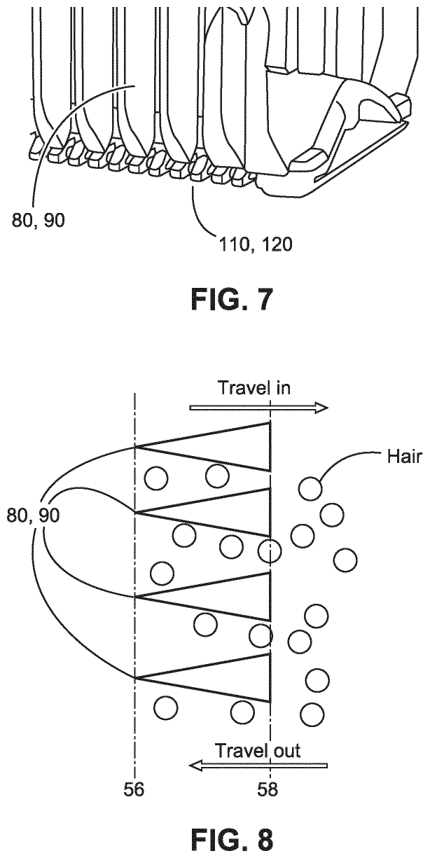

In an example, when the hair collector is connected to the hair cutting appliance the structure is configured to enable hair to pass through the plurality of openings to enter the cut hair collection chamber. A schematic exemplar of detailed embodiments is shown in FIGS. 7-8.

In an example, the hair that can pass through the plurality of openings is uncut hair that is then cut by the cutting element.

According to an example, the structure is configured to inhibit hair to pass through the plurality of openings to exit the cut hair collection chamber.

In an example, a total surface area of the structure at an outer surface 56 of the at least one side wall is less that a total surface of the structure at an inner surface 58 of the at least one side wall. A schematic exemplar of detailed embodiments is shown in FIGS. 8-9.

In other words, openings in walls of the hair collector are tapered to enable hair to enter, but not to exit when it has been cut off.

In this way hair orientation can be gradually influenced, whilst at the same time uncut hair can enter the collection chamber and be cut and can then not exit the chamber.

To put this another way, there is a slotted wall with teeth, which has a larger open outer surface area compared to the open inner surface area. In other words, the shaper edge of the teeth point outwards.

In an example, the structure comprises a comb like structure 80 with a plurality of teeth 90. Further detailed examples are shown in FIGS. 3-4, and 7-9.

In an example, the teeth taper from an outer surface of the at least one side wall to an inner surface of the at least one side wall.

Thus, the teeth being tapered enable hair to enter the hair collector and be cut, but then hair that is cut cannot exit. But, because the hair collector does not inhibit the cutting element from contacting the skin, the lifting and cutting performance of a hair cutting appliance such as a hybrid razor to which the hair collector is connected is not affected, because the teeth do not act at skin level but are positioned above the cutting element.

In an example, an angle of taper of the teeth is constant.

In this manner, by having a constant angle hair is moved through the structure from entry to exit into the hair collection chamber with a continuous counter force on the moving hair.

In an example, the angle of taper varies in going from the outer surface to the inner surface. Thus, the side walls of the teeth need not be flat, and can be curved and/or curved with flat regions. In an example, the side walls of the teeth can be concave or convex or be convex and concave and have be wavy shaped with both convex and concave regions.

In an example, the teeth have a triangular cross-section.

In an example, the triangular teeth have a rounded apex.

Thus, there is a possibly rounded apex at an outer wall, with an inner wall surface that is relatively larger.

In an example, a spatial period of the plurality of openings is configured to be an integer number of a spatial period of a plurality of openings of a razor guard of the cutting element. This is shown in a detailed example of FIG. 9.

In an example, teeth of the structure are pitched to a one to two ratio with respect to teeth of the razor guard. Other ratios are possible, such as one to one, one to three, and one to four.

In an example, when the hair collector is connected to the hair cutting appliance the plurality of the openings of the structure are configured to be aligned with an equivalent number of openings of the plurality of openings of the razor guard.

In an example, a first side wall 54a and a second side wall 54b of the plurality of walls of the second housing part each comprises the structure, and wherein the first side wall is on an opposite side of the second housing part to the second side wall. Further detailed examples are shown in FIGS. 3-4, and 7.

Thus, a double sided hair collector is provided that can then be fitted to a hair cutting appliance that has a cutting element that can cut in both forward and backward directions.

In an example, the hair collector is symmetric with respect to 180 degree rotation about a centre axis.

Thus, ease of alignment for connection to both double sided and single sided cutting appliances is provided and at the same time manufacturing costs are reduced.

According to an example, the hair collector comprises an attachment portion 70. The attachment portion is configured to attach the hair collector to the hair cutting appliance. Detailed examples are shown in FIGS. 3-6.

In an example, the attachment portion is configured to attach the hair collector to the cutting element. The attachment portion can operate in a number of different ways, as would be appreciated by the skilled person.

In an example, the attachment portion is configured to attach the hair collector to the hair cutting appliance in a releasable manner.

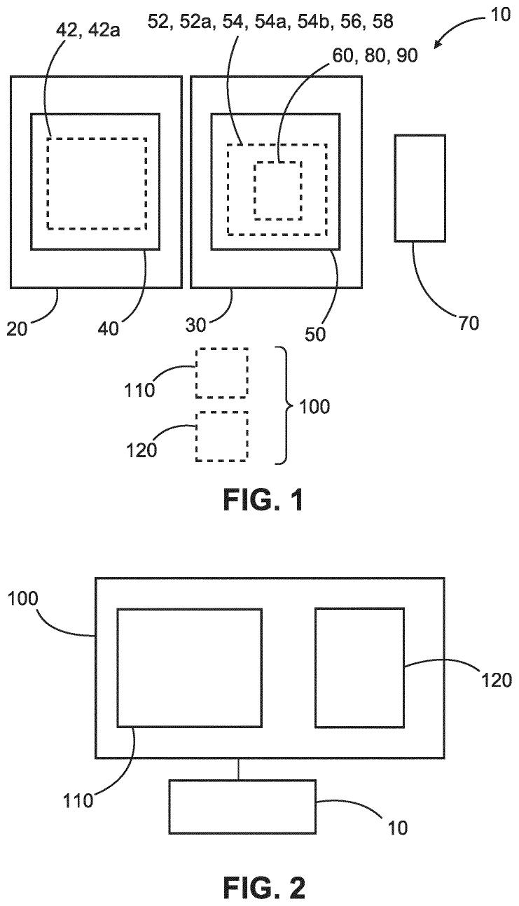

FIG. 2 relates to a hair cutting appliance 100 having a pivoting cutting element 110 and a razor guard 120, configured for shaving and/or trimming. A hair collector 10 as described with respect to FIG. 1 is connected to the hair cutting appliance.

In an example, the hair cutting appliance is configured to enable disconnection of the hair collector.

The connection of the hair collector 10 to the hybrid hair cutting appliance can however be permanent. Therefore, FIG. 2 also relates to an example of a hair cutting appliance 100 having a pivoting cutting element 110 and a razor guard 120, configured for shaving and/or trimming. However, now a hair collector 10a is integrated to the hair cutting appliance. The hair collector comprises a first housing part 20 and a second housing part 30. The first housing part comprises a plurality of walls 40. The second housing part comprises a plurality of walls 50. The first housing part is adjacent to the hair cutting element and the second housing part is adjacent to the first housing part. A cut hair collection chamber is formed comprising the plurality of walls of the first housing part, the plurality of walls of the second housing part, and the cutting element. The hair collector is configured such that the second housing part can pivot as the cutting element pivots. Reference to hair collector 10a refers to a hair collector that is integrated with the hair cutting appliance, and has not been specifically shown to in FIG. 2, but has the same features as hair collector 10 except that it is not able to be disconnected from the hair cutting appliance.

In an example, a drive system for the cutting element is located at least partially within the cut hair collection chamber.

In an example, the hair cutting appliance has a main housing, and wherein the hair collector is located at least partially around the cutting element between the cutting element and the main housing.

In an example, the hair cutting appliance is a hybrid hair cutting appliance, configured for both shaving and trimming.

In an example, the hair collector is configured such that the cutting element can contact skin of the user of the hair cutting appliance and at the same time the hair collector does not touch the skin of the user. In this way, the hair lifting and guiding function of a guard of the cutting element is not affected, whilst at the same time hair collection of cut hairs that would otherwise be sprayed around is enabled.

In an example, the skin is contacted just above the level of the cutting element in front of the razor guard. In this way, maximum collection of cut hairs that would otherwise be sprayed around is enabled and at the same time an improved comfort feeling to the user is provided.

In an example, the edges of the second housing part of the hair collector can be 1 mm above skin level when the cutting element is in contact with the skin. Other spacing distances can be utilized, such as 0.5 mm, 0.75 mm, 1.25 mm, 1.5 mm, 1.75 mm, 2 mm. In an example, the edges of the second housing part of the hair collector are just above skin level of the user and just in front of the razor guard.

In an example, the hair collector is configured such that the first housing part does not pivot as the cutting element pivots.

In an example, the hair collector is configured such that the first housing part can move towards and away from the cutting element as the second housing part pivots.

In an example, the hair collector is configured such that the second housing part can pivot about an axis that substantially coincides with a pivot axis of the cutting element.

In an example, at least one end wall 42 of the first housing part is configured to conform to at least one end wall 52 of the second housing part.

In an example, a curvature of at least one end wall of the first housing part is substantially the same as a curvature of at least one end wall of the second housing part.

In an example, a radius of curvature of at least one end wall of the first housing part is substantially the same as a radius of curvature of at least one end wall of the second housing part.

In an example, at least one end wall of the first housing part overlaps at least one end wall of the second housing part.

In an example, at least one end wall of the second housing part overlaps at least one end wall of the first housing part.

In an example, at least one end wall of the first housing part has a slot and wherein at least one end wall of the second housing part is configured to be located within the slot.

In an example, at least one end wall of the second housing part has a slot and wherein at least one end wall of the first housing part is configured to be located within the slot.

In an example, at least one end wall of the first housing part has a recess 42a with a lateral extent and wherein at least one end wall of the second housing part has a lug 52a configured to be located within the recess.

In an example, at least one end wall of the second housing part has a recess with a lateral extent and wherein at least one end wall of the first housing part has a lug configured to be located within the recess.

In an example, the recess in the at least one end wall of the first housing part has a radius of curvature centred on the axis about which the second housing part can pivot.

In an example, the recess in the at least one end wall of the second housing part has a radius of curvature centred on the axis about which the second housing part can pivot.

In an example, at least one side wall 54 of the plurality of walls of the second housing part comprises a structure 60 forming a plurality of openings.

In an example, the structure is configured to enable hair to pass through the plurality of openings to enter the cut hair collection chamber.

In an example, the structure is configured to enable hair to pass through the plurality of openings to enter the cut hair collection chamber.

In an example, the hair that can pass through the plurality of openings is uncut hair that is then cut by the cutting element.

In an example, the structure is configured to inhibit hair to pass through the plurality of openings to exit the cut hair collection chamber.

In an example, a total surface area of the structure at an outer surface of the at least one side wall is less that a total surface of the structure at an inner surface of the at least one side wall.

In an example, the structure comprises a comb like structure with a plurality of teeth.

In an example, the teeth taper from an outer surface of the at least one side wall to an inner surface of the at least one side wall.

In an example, an angle of taper of the teeth is constant.

In an example, the angle of taper varies in going from the outer surface to the inner surface. Thus, the side walls of the teeth need not be flat, and can be curved and/or curved with flat regions. In an example, the side walls of the teeth can be concave or convex or be convex and concave and have be wavy shaped with both convex and concave regions.

In an example, the teeth have a triangular cross-section.

In an example, the triangular teeth have a rounded apex.

In an example, a spatial period of the plurality of openings is configured to be an integer number of a spatial period of a plurality of openings of a razor guard of the cutting element.

In an example, teeth of the structure are pitched to a one to two ratio with respect to teeth of the razor guard. Other ratios are possible, such as one to one, one to three, and one to four.

In an example, when the hair collector is connected to the hair cutting appliance the plurality of the openings of the structure are configured to be aligned with an equivalent number of openings of the plurality of openings of the razor guard.

In an example, a first side wall and a second side wall of the plurality of walls of the second housing part each comprises the structure, and wherein the first side wall is on an opposite side of the second housing part to the second side wall.

In an example, the hair collector is symmetric with respect to 180 degree rotation about a centre axis.

The figures also relate to a method of collecting hair from a hair cutting appliance 100 having a pivoting cutting element 110. The method comprises connecting a hair collector 10 to the hair cutting appliance. The hair collector comprises a first housing part 20, and a second housing part 30. The first housing part comprises a plurality of walls 40. The second housing part comprises a plurality of walls 50. The first housing part is adjacent to the hair cutting element and the second housing part is adjacent to the first housing part. The collection of cut hair is provided via formation of a cut hair collection chamber, the cut hair collection chamber comprising the plurality of walls of the first housing part, the plurality of walls of the second housing part, and the cutting element. The hair collector is configured such that the second housing part can pivot as the cutting element pivots.

In an example, when the hair collector is connected to the hair cutting appliance, a drive system for the cutting element is located at least partially within the cut hair collection chamber.

In an example, a wall of the plurality of walls of the first housing part and the second housing part comprises an opening through which a connection part of a cutting assembly of the hair cutting appliance can be inserted, and wherein the cutting assembly comprises the cutting element. In this way, the hair collector can be placed over the cutting element and then connected to the hair cutting appliance.

In an example, the hair cutting appliance has a main housing, and wherein when the hair collector is connected to the hair cutting appliance the hair collector is located at least partially around the cutting element between the cutting element and the main housing.

In an example, the hair cutting appliance is a hybrid hair cutting appliance, configured for both shaving and trimming.

In an example, when the hair collector is connected to the hair cutting appliance, the hair collector is configured such that the cutting element can contact skin of the user of the hair cutting appliance and at the same time the hair collector does not touch the skin of the user.

In an example, when the hair collector is connected to the hair cutting appliance, the hair collector is configured such that the cutting element can contact skin of the user of the hair cutting appliance and at the same time the hair collector touches the skin of the user. In an example, the skin is contacted just above the level of the cutting element in front of the razor guard.

In an example, the edges of the second housing part of the hair collector can be 1 mm above skin level when the cutting element is in contact with the skin. Other spacing distances can be utilized, such as 0.5 mm, 0.75 mm, 1.25 mm, 1.5 mm, 1.75 mm, 2 mm. In an example, the edges of the second housing part of the hair collector are just above skin level of the user and just in front of the razor guard.

In an example, when the hair collector is connected to the hair cutting appliance, the hair collector is configured such that the cutting element can contact skin of a user of the hair cutting appliance.

In an example, when the hair collector is connected to the hair cutting appliance, the hair collector is configured such that the first housing part does not pivot as the cutting element pivots.

In an example, when the hair collector is connected to the hair cutting appliance, the hair collector is configured such that the first housing part can move towards and away from the cutting element as the second housing part pivots.

In an example, when the hair collector is connected to the hair cutting appliance, the hair collector is configured such that the second housing part can pivot about an axis that substantially coincides with a pivot axis of the cutting element.

In an example, when the hair collector is connected to the hair cutting appliance at least one end wall 42 of the first housing part is configured to conform to at least one end wall 52 of the second housing part.

In an example, a curvature of at least one end wall of the first housing part is substantially the same as a curvature of at least one end wall of the second housing part.

In an example, a radius of curvature of at least one end wall of the first housing part is substantially the same as a radius of curvature of at least one end wall of the second housing part.

In an example, when the hair collector is connected to the hair cutting appliance at least one end wall of the first housing part overlaps at least one end wall of the second housing part.

In an example, when the hair collector is connected to the hair cutting appliance at least one end wall of the second housing part overlaps at least one end wall of the first housing part.

In an example, at least one end wall of the first housing part has a slot and wherein when the hair collector is connected to the hair cutting appliance at least one end wall of the second housing part is configured to be located within the slot.

In an example, at least one end wall of the second housing part has a slot and wherein when the hair collector is connected to the hair cutting appliance at least one end wall of the first housing part is configured to be located within the slot.

In an example, at least one end wall of the first housing part has a recess 42a with a lateral extent and wherein at least one end wall of the second housing part has a lug 52a configured to be located within the recess.

In an example, at least one end wall of the second housing part has a recess with a lateral extent and wherein at least one end wall of the first housing part has a lug configured to be located within the recess.

In an example, the recess in the at least one end wall of the first housing part has a radius of curvature centred on the axis about which the second housing part can pivot.

In an example, the recess in the at least one end wall of the second housing part has a radius of curvature centred on the axis about which the second housing part can pivot.

In an example, at least one side wall 54 of the plurality of walls of the second housing part comprises a structure 60 forming a plurality of openings.

In an example, the structure is configured to enable hair to pass through the plurality of openings to enter the cut hair collection chamber.

In an example, when the hair collector is connected to the hair cutting appliance the structure is configured to enable hair to pass through the plurality of openings to enter the cut hair collection chamber.

In an example, the hair that can pass through the plurality of openings is uncut hair that is then cut by the cutting element.

In an example, the structure is configured to inhibit hair to pass through the plurality of openings to exit the cut hair collection chamber.

In an example, a total surface area of the structure at an outer surface of the at least one side wall is less that a total surface of the structure at an inner surface of the at least one side wall.

In an example, the structure comprises a comb like structure with a plurality of teeth.

In an example, the teeth taper from an outer surface of the at least one side wall to an inner surface of the at least one side wall.

In an example, an angle of taper of the teeth is constant.

In an example, the angle of taper varies in going from the outer surface to the inner surface.

In an example, the teeth have a triangular cross-section.

In an example, the triangular teeth have a rounded apex.

In an example, a spatial period of the plurality of openings is configured to be an integer number of a spatial period of a plurality of openings of a razor guard of the cutting element.

In an example, teeth of the structure are pitched to a one to two ratio with respect to teeth of the razor guard. Other ratios are possible, such as one to one, one to three, and one to four.

In an example, when the hair collector is connected to the hair cutting appliance the plurality of the openings of the structure are configured to be aligned with an equivalent number of openings of the plurality of openings of the razor guard.

In an example, a first side wall and a second side wall of the plurality of walls of the second housing part each comprises the structure, and wherein the first side wall is on an opposite side of the second housing part to the second side wall.

In an example, the hair collector is symmetric with respect to 180 degree rotation about a centre axis.

In an example, the hair collector comprises an attachment portion 70, and the method comprises attaching the hair collector to the hair cutting appliance via the attachment portion.

In an example, the attachment portion is configured to attach the hair collector to the cutting element.

In an example, the attachment portion is configured to attach the hair collector to the hair cutting appliance in a releasable manner.

The hair collector for a hair cutting appliance having a pivoting cutting element, and hair cutting appliance with such a hair collector are now additionally described in conjunction with specific embodiments shown in FIGS. 3-10.

As shown in FIG. 3 a cut hair particle collection space or chamber is provided between a housing of a hair cutting appliance (both not shown) and a cutting element 110 of the hybrid hair cutting appliance. This is achieved by placing a (double sided) hair collector 10, over the cutting element. The hair collector is formed from a first housing part 20 and a second housing part 30. The second housing part sits adjacent to the cutting element between the cutting element and the first housing part. Side walls 54a and 54b of the second housing part have a comb like structure 60, 80 having a plurality of teeth 90. The cut hair collection chamber is formed by walls 40 of the first housing part and the walls of the second housing part and the cutting element. The hair collector in this example does not touch the skin to allow optimal hair catching by the cutting element and allows (longer) hairs to easily move through the openings, and not affect the functioning of a razor guard 120. As further described along with FIG. 10, as the teeth of the second housing part of the hair collector do not act on the skin level and are positioned above the cutting element, the lifting and cutting performance of a cutting appliance, such as a hybrid cutting appliance, is not affected. For the specific embodiment shown in FIG. 10, the teeth of the second housing part of the hair collector are 1 mm above skin level when the cutting element touches the skin, and are positioned just in front of a razor guard. In this way, the vast amount of cut hair is collected and is not sprayed, and the first and second housing parts of the hair collector can be easily placed over the cutting assembly. However, in a specific embodiment the hair collector teeth can contact the skin and at the same time the cutting element touch the skin.

Continuing with FIG. 3 the hair collector forms a collection chamber with the cutting element, and is in effect a cap that provides a removable compartment for the collection of cut hairs. A fixation and alignment system enables the hair collector to be guided into position and locked onto the cutting assembly. The hair collector has a filtering inlet system, that enables hairs including long hairs to enter the system and be cut and held within the hair collection chamber formed. The teeth of opposing walls of the hair collector each are a comb like element that are shaped such that when seen in a hair travelling direction towards the cutting direction they guide hairs and when seen in the opposite direction they block hair debris. This is achieved for example by having a triangular shape of which the top or apex is pointing away from the cutting element. However, the hair collector comes in two housing parts. One housing part sits adjacent to the cutting element, this is called the second housing part. Another housing part, called the first housing part then sits in effect on top of the second housing part, and can be in effect separated by a small gap from the second housing part but can be contacting it. As the cutting element can pivot, the second housing part can also pivot, facilitated by having lugs in end walls that connect into recesses in the end walls of the first housing part, and pivot movement of the second housing part leads to movement of the lugs within the recesses. The recesses have a radius of curvature such that the second housing part pivots about in effect the same axis that the cutting element itself pivots. The lug and recess are shown in detail in FIG. 6 and the second housing part can be connected in a releasable manner to the first housing part.

Continuing with FIG. 3, the two housing parts of the hair collector can easily be positioned over the cutting assembly because the top wall of both the first housing part and the second housing part has an opening, and hair collector locks onto the cutting assembly. The first housing part locks, or clicks, onto the cutting assembly and then the second housing part connects to the first housing part by the lug and recess system discussed above, to enable pivot movement of the second housing part to follow the pivot movement of the cutting element. However, in other embodiments the first housing part can move away from the second housing part.

As shown in FIG. 3 two opposing side walls 54a and 54b of the second housing part 30 have a structure 60 in the form of a have the comb like structure 80 with teeth 90. The first and second parts of the hair collector can each be made by single part injection molding.

As shown in FIG. 3 the hair collector can be in a form where the first housing part in effect is adjacent to the second housing part. The end walls 42 of the first housing part can then have the same radius of curvature as the end walls 52 of the second housing part. In this way, a separation between the two can be maintained as the second housing part pivots.

However, as shown in FIGS. 4-6, the end walls 52 of the second housing part can overlap the end walls 42 of the first housing part, to provide mechanical stability and to help contain cut hairs within the hair collection chamber. As shown in FIG. 6, a lug and recess system, discussed above enables the second part to pivot in a precisely controlled manner.

The hair filtering and collection system is shown in more detail in FIGS. 7 and 8. A semi open filtering system is provided that enables hair to enter a hair collection chamber through the hair filter system but blocks hair from leaving the chamber after it is cut. The walls of the second housing part of the hair collector are positioned just above the cutting element, where teeth of the comb structure of the walls do not interfere with the hair lifting ability of the razor guard. The size of the slots between the teeth is optimized to enable hair entry over the full frontal surface but largely block hairs from leaving the inner hair collection chamber. The teeth in the side walls of the second part of the hair collector function as a funnel, making it easy for hair to travel inwards but harder for hair to travel outwards. To optimize this effect, the outer (frontal) surface of the teeth is small and the inner (back) surface is large. The size and shape of the outer teeth surface is designed to function as described, but also is deigned in order to be compatible with injection molding manufacturing in this specific example, The size of the inner surface is designed with a view on entry performance, and the rate at which hairs can enter the system. The teeth are shaped in such a way that they gradually influence hair orientation. A fixed angle enables the hair to move towards the point of exit with a continuous counter force on the moving hair, but other shapes also have utility. The smaller the angle, the less hairs get pushed out of the system.

FIG. 9 shows a plan view of an exemplar geometry of the teeth of one side wall of the second housing part of the hair collector, where the teeth start at an outer surface 56 and become wider in extending to an inner surface 58. In this specific example, the teeth are pitched in a one to two ratio with teeth of a razor guard, but other ratios are possible.

It has to be noted that embodiments of the invention are described with reference to different subject matters. In particular, some embodiments are described with reference to method type claims whereas other embodiments are described with reference to the device type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

1. A hair collector for a hair cutting appliance having a pivoting cutting element, the hair collector comprising:
a first housing part; and
a second housing part;
wherein, the first housing part comprises a plurality of walls;
wherein, the second housing part comprises a plurality of walls;
wherein, when the hair collector is connected to the hair cutting appliance, the first housing part is adjacent to the hair cutting element and the second housing part is adjacent to the first housing part;
wherein, when the hair collector is connected to the hair cutting appliance, a cut hair collection chamber is formed, the cut hair collection chamber comprising the plurality of walls of the first housing part, the plurality of walls of the second housing part, and the cutting element;
wherein, when the hair collector is connected to the hair cutting appliance, the hair collector is configured such that the second housing part can pivot as the cutting element pivots; and
wherein, when the hair collector is connected to the hair cutting appliance, the hair collector is configured such that the first housing part does not pivot as the cutting element pivots.

2. Hair collector according to claim 1, wherein, when the hair collector is connected to the hair cutting appliance, the hair collector is configured such that the cutting element can contact skin of a user of the hair cutting appliance.

3. Hair collector according to claim 1, wherein, when the hair collector is connected to the hair cutting appliance, the hair collector is configured such that the second housing part can pivot about an axis that substantially coincides with a pivot axis of the cutting element.

4. Hair collector according to claim 1, wherein when the hair collector is connected to the hair cutting appliance at least one end wall of the first housing part is configured to conform to at least one end wall of the second housing part.

5. Hair collector according to claim 1, wherein a curvature of at least one end wall of the first housing part is substantially the same as a curvature of at least one end wall of the second housing part.

6. Hair collector according to claim 1, wherein when the hair collector is connected to the hair cutting appliance at least one end wall of the first housing part overlaps at least one end wall of the second housing part; and/or wherein when the hair collector is connected to the hair cutting appliance at least one end wall of the second housing part overlaps at least one end wall of the first housing part.

7. Hair collector according to claim 1, wherein at least one end wall of the first housing part has a slot and wherein when the hair collector is connected to the hair cutting appliance at least one end wall of the second housing part is configured to be located within the slot; and/or wherein at least one end wall of the second housing part has a slot and wherein when the hair collector is connected to the hair cutting appliance at least one end wall of the first housing part is configured to be located within the slot.

8. Hair collector according to claim 1, wherein at least one end wall of the first housing part has a recess with a lateral extent and wherein at least one end wall of the second housing part has a lug configured to be located within the recess.

9. Hair collector according to claim 8, wherein the recess in the at least one end wall of the first housing part has a radius of curvature centred on the axis about which the second housing part can pivot.

10. Hair collector according to claim 1, wherein at least one side wall (54) of the plurality of walls of the second housing part comprises a structure (60) forming a plurality of openings.

11. Hair collector according to claim 10, wherein the structure is configured to inhibit hair to pass through the plurality of openings to exit the cut hair collection chamber.

12. Hair collector according to claim 1, wherein the hair collector comprises an attachment portion, and wherein the attachment portion is configured to attach the hair collector to the hair cutting appliance.

13. A hair cutting appliance having a pivoting cutting element and a razor guard, configured for shaving and/or trimming, to which is connected a hair collector claim 1.

14. A hair cutting appliance having a pivoting cutting element and a razor guard, configured for shaving and/or trimming, to which is integrated a hair collector, wherein the hair collector comprises a first housing part and a second housing part; wherein the first housing part comprises a plurality of walls; wherein the second housing part comprises a plurality of walls; wherein, the first housing part is adjacent to the hair cutting element and the second housing part is adjacent to the first housing part; wherein, a cut hair collection chamber is formed comprising the plurality of walls of the first housing part, the plurality of walls of the second housing part, and the cutting element; wherein the hair collector is configured such that the second housing part can pivot as the cutting element pivots; and wherein the hair collector is configured such that the first housing part does not pivot as the cutting element pivots.

15. A method of collecting hair from a hair cutting appliance having a pivoting cutting element, the method comprising connecting a hair collector to the hair cutting appliance, wherein the hair collector comprises:
a first housing part; and
a second housing part;
wherein, the first housing part comprises a plurality of walls;
wherein, the second housing part comprises a plurality of walls;
wherein, the first housing part is adjacent to the hair cutting element and the second housing part is adjacent to the first housing part;
wherein, the collection of cut hair is provided via formation of a cut hair collection chamber, the cut hair collection chamber comprising the plurality of walls of the first housing part, the plurality of walls of the second housing part, and the cutting element;
wherein, the hair collector is configured such that the second housing part can pivot as the cutting element pivots; and
wherein, when the hair collector is connected to the hair cutting appliance, the hair collector is configured such that the first housing part does not pivot as the cutting element pivots.
